(19) United States
(12) Patent Application Publication
(10) Pub. No.: US 2025/0150559 A1
(43) Pub. Date: May 8, 2025

(54) MOVING WIND TURBINE BLADE INSPECTION

(71) Applicant: Thales Holdings UK Plc, Reading, Berkshire (GB)

(72) Inventors: Barry CONNOR, Glasgow (GB); Richard MAGUIRE, Glasgow (GB); Fraser O'NEILL, Glasgow (GB)

(73) Assignee: Thales Holdings UK Plc, Reading, Berkshire (GB)

(21) Appl. No.: 18/835,277

(22) PCT Filed: Feb. 3, 2023
(86) PCT No.: PCT/GB2023/050248

§ 371 Date: Aug. 1, 2024

(30) Foreign Application Priority Data
Feb. 4, 2022 (GB) 2201491.4

(51) Int. Cl. H04N 7/18; F03D 17/00; G06T 7/00; G06T 7/13; G06T 7/73; H04N 23/68; H04N 23/695; H04N 23/698

(52) U.S. Cl. CPC H04N 7/188; F03D 17/003; F03D 17/028; G06T 7/0002; G06T 7/13; G06T 7/73; H04N 7/181; H04N 23/6812; H04N 23/685; H04N 23/695; H04N 23/698; G06T 2207/10032; G06T 2207/20061; G06T 2207/20224; G06T 2207/30252

(57) ABSTRACT

A method for imaging a region of a moving blade of a wind turbine includes using a wider field-of-view (WFoV) camera to capture a plurality of WFoV images of at least part of the moving blade in a field-of-view (FoV) of the WFoV camera, determine a trigger time when an edge of the moving blade to calculate one or more NFoV image capture times when the edge of the moving blade, or a body of the moving blade, is, or will be, in the FoV of a NFoV camera, and using the NFoV camera to capture one or more NFoV images. The one or more NFoV images of the region of the moving blade may be analysed to identify any damage or defects in the moving blade without any need to interrupt the motion of the blades of the wind turbine.

### FIELD

The present disclosure relates to imaging systems and methods for imaging or inspecting one or more moving blades of a wind turbine such as an offshore wind turbine or an onshore wind turbine.

### BACKGROUND

In response to the ever increasing reliance on wind power, offshore wind farms in particular are efficient in extracting power from the wind. However, the harsh operating environments of wind farms can make it difficult to maintain and inspect wind turbines. It is also a dangerous environment for manual maintenance. For compliance reasons, windfarm operators need to show evidence of regular inspection and to identify any potential defects or damage that could reduce the life of the wind turbine or the power extraction efficiency. Current inspection methods require that the wind turbines are shut down and inspected either manually by rope access or via use of aerial technology such as unmanned aerial technology, thereby reducing revenue.

A rope survey requires one or more surveyors, who are specially trained in rope access and working at height, to inspect each blade whilst the blades are stationary. The surveyors scale the wind turbine and then inspect each blade by eye whilst abseiling down the wind turbine and taking photographs of any damage observed using a suitable camera. However, this places the surveyors at significant risk when conducting inspections and relies on the surveyors spotting the defects manually as the inspection is carried out.

Aerial vehicles such as unmanned aerial vehicles or drones may be used to inspect each wind turbine blade whilst the blades are stationary. A drone may survey the surface of the blade and record video footage of the blade. The footage can then be inspected remotely by the drone operator or recorded for off-line inspection at a later date.

The foregoing known wind turbine blade inspection methods are costly and time-consuming not least because they require that the wind turbines are shut down during inspection, resulting in no electricity been produced and lost revenue for the wind turbine operator. These known inspection methods also require surveyors to be physically at the wind farm. In the case of offshore wind turbines, this may require that the surveyors are transported to the windfarm by a crew transfer vessel. Such inspection techniques also mean that inspection and maintenance are reactive activities rather than preventative activities. In effect, this may mean that, by the time a wind turbine is inspected, damage may have progressed to the point where the damage is more costly to repair than it would have been if the damage had been identified earlier. In addition, both known wind turbine inspection techniques are limited in their application by the weather because the weather conditions have to be benign enough to facilitate safe inspection either by rope surveyors or by drones. The duration of drone flight times may also be limited. Furthermore, use of drones may be limited in the proximity of other moving wind turbines in the same wind farm as the stationary wind turbine under inspection. Consequently, such traditional wind turbine inspection methods are significantly restricted, especially offshore.

### SUMMARY

According to an aspect of the present disclosure there is provided a method for imaging a region of a moving blade of a wind turbine, the method comprising:
using a wider field-of-view (WFoV) camera to capture a plurality of WFoV images of at least part of the moving blade in a field-of-view (FoV) of the WFOV camera;
using the captured plurality of WFoV images of at least part of the moving blade to determine a trigger time when an edge of the moving blade is, or will be, in a triggering region;
using the determined trigger time and a known spatial relationship between the triggering region and a FoV of a narrower field-of-view (NFoV) camera to calculate one or more NFoV image capture times when the edge of the moving blade, or a body of the moving blade, is, or will be, in the FoV of the NFoV camera; and
using the NFoV camera to capture one or more NFoV images of the region of the moving blade at the calculated one or more NFoV image capture times.

According to an aspect of the present disclosure there is provided a method for imaging regions of the moving blade of a wind turbine, the method comprising:
sequentially scanning the FoV of the NFoV camera across a plurality of radial positions relative to an axis of rotation of the moving blades of the wind turbine; and
for each radial position, imaging a region of the moving blade of the wind turbine according to the method as described above.

According to an aspect of the present disclosure there is provided a method for imaging corresponding regions of the moving blades of a wind turbine, the method comprising imaging a corresponding region of each moving blade according to the method of imaging a region of a moving blade of a wind turbine as described above.

According to an aspect of the present disclosure there is provided a method for imaging the moving blades of a wind turbine, the method comprising:
sequentially scanning the FoV of the NFoV camera across a plurality of radial positions relative to an axis of rotation of the moving blades of the wind turbine; and
for each radial position, imaging the corresponding regions of the moving blades of the wind turbine according to the method as described above.

According to an aspect of the present disclosure there is provided a method for imaging the moving blades of a wind turbine, the method comprising:
using a wider field-of-view (WFoV) camera and a narrower field-of-view (NFoV) camera to image a plurality of regions of each of the moving blades by:
   sequentially scanning a field-of-view (FoV) of the NFoV camera across a plurality of radial positions relative to an axis of rotation of the moving blades; and
   using the WFoV and NFoV cameras to image, at each radial position, a corresponding region of each moving blade,
wherein using the WFoV and NFoV cameras to image, at any one of the radial positions, the corresponding region of any one of the moving blades comprises:
   using the WFoV camera to capture a plurality of WFoV images of at least part of the moving blade in a FoV of the WFoV camera;
   using the captured plurality of WFoV images of at least part of the moving blade to determine a trigger time when an edge of the moving blade is, or will be, in a triggering region;
   using the determined trigger time and a known spatial relationship between the triggering region and a FoV of the NFoV camera to calculate one or more NFoV image capture times when the edge of the moving blade, or a body of the moving blade, is, or will be, in the FoV of the NFoV camera; and
   using the NFoV camera to capture one or more NFoV images of the region of the moving blade at the calculated one or more NFoV image capture times.

Optionally, the triggering region has a known size. Optionally, the triggering region has a known shape. Optionally, the triggering region has a known position. Optionally, the triggering region has a known orientation.

Optionally, the triggering region is the same as the FoV of the NFoV camera. Optionally, the triggering region is different to the FoV of the NFoV camera.

Optionally, a size of the triggering region is the same as a size of the FoV of the NFoV camera. Optionally, a size of the triggering region is different to, for example greater than or smaller than, a size of the FoV of the NFoV camera.

Optionally, a shape of the triggering region is the same or different to a shape of the FoV of the NFoV camera.

Optionally, one or more dimensions of the triggering region is/are the same as one or more corresponding dimensions of the FoV of the NFoV camera. Optionally, one or more dimensions of the triggering region is/are different to, for example greater than or smaller than, one or more corresponding dimensions of the FoV of the NFoV camera.

Optionally, an angular range of the triggering region relative to an axis of rotation of the moving blades of the wind turbine is the same as an angular range of the FoV of the NFoV camera relative to the axis of rotation of the moving blades of the wind turbine. Optionally, an angular range of the triggering region relative to the axis of rotation of the moving blades of the wind turbine is different to, for example greater than or smaller than, an angular range of the FoV of the NFoV camera relative to the axis of rotation of the moving blades of the wind turbine.

Optionally, a dimension of the triggering region in a vertical direction is the same as a dimension of the FoV of the NFOV camera in the vertical direction. Optionally, a dimension of the triggering region in the vertical direction is different to, for example greater than or smaller than, a dimension of the FoV of the NFoV camera in the vertical direction.

Optionally, a dimension of the triggering region in a radial direction relative to an axis of rotation of the moving blades of the wind turbine is the same as a dimension of the FoV of the NFOV camera in the radial direction. Optionally, a dimension of the triggering region in a radial direction relative to an axis of rotation of the moving blades of the wind turbine is different to, for example greater than or smaller than, a dimension of the FoV of the NFoV camera in the radial direction.

Optionally, a dimension of the triggering region in a horizontal direction is the same as a dimension of the FoV of the NFoV camera in the horizontal direction. Optionally, a dimension of the triggering region in the horizontal direction is different to, for example greater than or smaller than, a dimension of the FoV of the NFoV camera in the horizontal direction.

Optionally, a position of the triggering region is the same as a position of the FoV of the NFoV camera.

Optionally, a position of the triggering region is different to a position of the FoV of the NFoV camera. Optionally, a position of the triggering region has a known offset relative to a position of the FoV of the NFoV camera in a circumferential direction relative to the axis of rotation of the moving blades of the wind turbine.

Optionally, a size of the triggering region is adjustable.

Optionally, a shape of the triggering region is adjustable.

Optionally, one or more dimensions of the triggering region is/are adjustable.

Optionally, the position of the triggering region is adjustable, for example relative to a position of the FoV of the NFoV camera.

Optionally, the orientation of the triggering region is adjustable, for example relative to an orientation of the FoV of the NFoV camera.

Optionally, the triggering region depends on where the FoV of the NFoV camera is pointing. Optionally, the method comprises selecting the triggering region according to where the FoV of the NFoV camera is pointing.

Optionally, the triggering region depends on a distance between the NFoV camera and the moving blade of the wind turbine. Optionally, the method comprises selecting the triggering region according to the distance between the NFoV camera and the moving blade of the wind turbine.

Optionally, using the WFoV camera to capture the plurality of WFOV images of at least part of the moving blade of the wind turbine comprises using the WFoV camera to repeatedly capture WFoV images of at least part of the moving blade of the wind turbine at a plurality of known WFoV image capture times, wherein successive known WFoV image capture times are separated by a sampling period which is less than a period of rotation of the blade of the wind turbine.

Optionally, using the captured plurality of WFoV images of at least part of the moving blade to determine the trigger time comprises:
determining, for each WFoV image capture time, an angle of each edge of the moving blade relative to a reference direction from the captured plurality of WFoV images of at least part of the moving blade;
identifying the trigger time to be the current WFoV image capture time if one or both angles of the edges of the moving blade relative to the reference direction at the current WFoV image capture time falls inside a predetermined range of angles defining the triggering region relative to the reference direction and if the angles of both edges of the moving blade relative to the reference direction at the previous WFoV image capture time, which immediately precedes the current WFoV image capture time, fall outside the predetermined range of angles defining the triggering region relative to the reference direction.

Optionally, determining the angle of each edge of the moving blade relative to the reference direction at a current WFoV image capture time comprises:
subtracting the previous captured WFOV image of at least part of the moving blade captured at the previous WFoV image capture time, which immediately precedes the current WFoV image capture time, from the current captured WFoV image of at least part of the moving blade captured at the current WFoV image capture time to generate a subtracted WFoV image of at least part of the moving blade;
applying Canny edge detection to the subtracted WFoV image;
applying a gradient morphological transform to generate thresholded Hough lines; and
determining the angles of the edges of the moving blade relative to the reference direction at the current WFOV image capture time to be the angles of the thresholded Hough lines relative to the reference direction.

Optionally, using the captured plurality of WFoV images of at least part of the moving blade to determine the trigger time comprises:
determining first and second angles of each edge of the moving blade relative to a reference direction at first and second known WFOV image capture times of captured first and second WFoV images respectively of the captured plurality of WFoV images of at least part of the moving blade;
determining a speed of rotation of the moving blade based on the determined first and second angles of one or both edges of the moving blade corresponding to the first and second known WFoV image capture times; and
using one or both of the first and second known WFoV image capture times and the determined speed of rotation of the moving blade to calculate the trigger time when one or both of the angles of the edges of the moving blade will enter a predetermined range of angles relative to the reference direction which define a triggering region.

Optionally, determining the first or second angle of each edge of the moving blade relative to the reference direction comprises:

subtracting the previous captured WFOV image of at least part of the moving blade captured at the previous WFoV image capture time, which immediately precedes the first or second known WFoV image capture time, from the captured first or second WFoV image of at least part of the moving blade captured at the first or second known WFoV image capture time to generate a subtracted WFoV image of at least part of the moving blade corresponding to the first or second known WFoV image capture time;
applying Canny edge detection to the subtracted WFoV image;
applying a gradient morphological transform to generate thresholded Hough lines; and
determining the first or second angle of each edge of the moving blade relative to the reference direction at the first or second known WFoV image capture time to be the angles of the thresholded Hough lines relative to the reference direction.

Optionally, the reference direction is vertically upwards.

Optionally, the predetermined range of angles defining the triggering region relative to the reference direction is between 85° and 95°, between 88° and 92° or between 89° and 91°.

Optionally, the predetermined range of angles defining the triggering region relative to the reference direction is between 265° and 275°, between 268° and 272° or between 269° and 271°.

Optionally, the method comprises translating the WFoV and NFoV cameras together along a path around the wind turbine and using the WFoV and NFoV cameras to image each moving blade from one or more predetermined different vantage points on the path.

Optionally, the method comprises translating the WFoV and NFoV cameras together along a path around the wind turbine and using the WFoV and NFoV cameras to image one or both sides of each moving blade from one or more predetermined different vantage points on the path.

Optionally, the method comprises translating the WFoV and NFoV cameras together along a path around the wind turbine and using the WFoV and NFoV cameras to image one or both edges of each moving blade from one or more predetermined different vantage points on the path.

Optionally, the method comprises translating the WFoV and NFoV cameras together along the path around the wind turbine autonomously.

Optionally, the method comprises receiving a signal including information relating to the wind direction and/or the direction in which the wind turbine is pointing and determining the path around the wind turbine based on the wind direction and/or the direction in which the wind turbine is pointing, a known or stored position of the wind turbine, and a known or stored length of the blades of the wind turbine.

Optionally, the method comprises receiving a signal including information relating to the wind direction and/or the direction in which the wind turbine is pointing from a transmitter or a transponder of the wind turbine.

Optionally, the method comprises receiving a signal including information relating to the wind direction from a wind direction sensor provided with the imaging system or a movable platform on which the imaging system is mounted.

Optionally, each predetermined different vantage point is located at a position at or around the same level as a base of the wind turbine, wherein the position defines an acute look-up angle relative to a plane of rotation of the moving blades of the wind turbine. Optionally, the method comprises angling the WFOV and NFoV cameras upwardly towards the plane of rotation of the moving blades of the wind turbine at the acute look-up angle. Such a method may facilitate imaging of the pressure and sucking surfaces of each blade and imaging of both the leading and trailing edges of each blade.

Optionally, the acute look-up angle is in the region of 45°. This may allow at least one edge of the blade to be imaged.

Optionally, each predetermined different vantage point is located at a position at or around the same level as the base of the wind turbine at a distance from the base along a direction perpendicular to the plane of rotation of the moving blades of the wind turbine which is equal to the distance between the base and a nacelle of the wind turbine.

Optionally, each predetermined different vantage point is located at a position at or around the same level as the uppermost position of the plane of rotation of the moving blades of the wind turbine, wherein the position defines an acute look-down angle relative to the plane of rotation of the moving blades of the wind turbine. Optionally, the method comprises angling the WFoV and NFoV cameras downwardly towards the nacelle of the wind turbine at a look-down angle relative to the plane of rotation of the moving blades of the wind turbine. Such a method may facilitate imaging of the pressure and sucking surfaces of each blade and imaging of both the leading and trailing edges of each blade.

Optionally, the acute look-down angle is in the region of 45°. This may allow at least one edge of the blade to be imaged.

Optionally, each predetermined different vantage point is located at a position at or around the same level as the uppermost position of the plane of rotation of the moving blades of the wind turbine at a distance from the uppermost position along a direction perpendicular to the plane of rotation of the moving blades of the wind turbine which is equal to the distance between the uppermost position and a nacelle of the wind turbine.

Optionally, the WFoV and NFoV cameras form part of an imaging system and the method comprises stabilising the WFOV and NFoV cameras against motion of the imaging system.

Optionally, the imaging system comprises an enclosure, wherein the WFoV and NFoV cameras are both located within, and fixed to, the enclosure and the method comprises stabilising the enclosure against motion of the imaging system.

Optionally, using the WFoV and NFoV cameras to sequentially image the plurality of different regions of each moving blade comprises using the WFoV and NFoV cameras to sequentially image the plurality of different regions of one of the moving blades and then using the WFoV and NFoV cameras to sequentially image the plurality of different regions of a different one of the moving blades until the plurality of different regions of each of the moving blades have been imaged.

Optionally, using the WFoV and NFoV cameras to sequentially image the plurality of different regions of each moving blade comprises using the WFOV and NFoV cameras to sequentially image the corresponding regions of each of the moving blades at one radial position and then using the WFoV and NFoV cameras to sequentially image the corresponding regions of each of the moving blades at a different one of the radial positions until the plurality of different regions of each of the moving blades have been imaged.

Optionally, sequentially scanning the FoV of the NFoV camera across the plurality of radial positions comprises sequentially re-orienting the NFoV camera so as to sequentially scan the FoV of the NFoV camera across the plurality of radial positions.

Optionally, the method comprises performing the sequential scanning of the field-of-view (FoV) of the NFoV camera and the sequential imaging of the plurality of different regions of each moving blade autonomously according to a pre-programmed sequence.

According to an aspect of the present disclosure there is provided an imaging system for imaging a region of a moving blade of a wind turbine, the imaging system comprising:
a wider field-of-view (WFoV) camera;
a narrower field-of-view (NFoV) camera; and
a processing resource configured for communication with the WFoV camera and the NFoV camera,
wherein the processing resource is configured to:
control the WFoV camera to capture a plurality of WFoV images of at least part of the moving blade of the wind turbine in a field-of-view (FoV) of the WFoV camera;
use the captured plurality of WFoV images of at least part of the moving blade to determine a trigger time when an edge of the moving blade is, or will be, in a triggering region;
use the determined trigger time and a known spatial relationship between the triggering region and a FoV of the NFoV camera to calculate one or more NFoV image capture times when the edge of the moving blade, or a body of the moving blade, is, or will be, in a FoV of the NFoV camera; and
control the NFoV camera to capture one or more NFoV images of the region of the moving blade at the calculated one or more NFoV image capture times.

According to an aspect of the present disclosure there is provided an imaging system for imaging the moving blades of a wind turbine, the imaging system comprising:
a wider field-of-view (WFoV) camera;
a narrower field-of-view (NFoV) camera; and
a processing resource configured for communication with the WFoV camera and the NFoV camera,
wherein the processing resource is configured to control the WFOV camera and the NFoV camera to image a plurality of regions of each of the moving blades by:
   sequentially scanning a field-of-view (FoV) of the NFoV camera across a plurality of radial positions relative to an axis of rotation of the moving blades; and
   using the WFoV and NFoV cameras to image, at each radial position, a corresponding region of each moving blade,
wherein controlling the WFOV and NFOV cameras to image, at any one of the radial positions, the corresponding region of any one of the moving blades comprises:
controlling the WFOV camera to capture a plurality of WFoV images of at least part of the moving blade of the wind turbine in a field-of-view (FoV) of the WFoV camera;
using the captured plurality of WFoV images of at least part of the moving blade to determine a trigger time when an edge of the moving blade is, or will be, in a triggering region;
using the determined trigger time and a known spatial relationship between the triggering region and a FoV of the NFoV camera to calculate one or more NFoV image capture times when the edge of the moving blade, or a body of the moving blade, is, or will be, in a FoV of the NFoV camera; and
controlling the NFoV camera to capture one or more NFoV images of the region of the moving blade at the calculated one or more NFoV image capture times.

Optionally, the WFoV camera is sensitive to one or more of the following: visible light, near-infrared (NIR) light, short-wavelength infrared (SWIR) light, mid-wavelength infrared (MWIR) light, and long-wavelength infrared (LWIR) light.

Optionally, the WFOV camera is a monochrome camera or a colour camera.

Optionally, the NFoV camera is sensitive to one or more of the following: visible light, near-infrared (NIR) light, short-wavelength infrared (SWIR) light, mid-wavelength infrared (MWIR) light, and long-wavelength infrared (LWIR) light.

Optionally, the NFoV camera is a monochrome camera or a colour camera.

Optionally, the WFoV and NFoV cameras are both visible cameras.

Optionally, the NFoV camera has a higher resolution than the WFoV camera.

Optionally, the NFoV camera has an integration time of less than 1 ms, less than 500 μs or less than 100 μs.

Optionally, the WFoV and NFoV cameras are fixed relative to one another.

Optionally, the imaging system comprises a gimbal system for use in controlling an orientation of the WFoV and NFoV cameras, wherein the processing resource and the gimbal system are configured for communication.

Optionally, the processing resource is configured to control the gimbal system so as to sequentially scan the FoV of the NFoV camera across the plurality of radial positions relative to the axis of rotation of the moving blades.

Optionally, the processing resource is configured to control the gimbal system so as to stabilise the WFoV and NFoV cameras against motion of the imaging system.

Optionally, the imaging system comprises a sensor arrangement for measuring a position, orientation and/or an acceleration of the WFOV and NFoV cameras, wherein the processing resource and the sensor arrangement are configured for communication. Optionally, the sensor arrangement comprises a GPS sensor, a compass, one or more accelerometers, one or more gyroscopic sensors, and/or an inertial measurement unit.

Optionally, the sensor arrangement comprises an Attitude Heading and Reference System (AHARS).

Optionally, the processing resource is configured to control the gimbal system so as to control the orientation of the WFoV and NFoV cameras in response to one or more signals received from the one or more sensors so as to stabilise the WFOV and NFoV cameras against motion of the imaging system.

Optionally, the imaging system comprises an enclosure, wherein the WFOV and NFoV cameras are both located within, and fixed to, the enclosure.

Optionally, the enclosure is sealed so as to isolate the WFoV and NFoV cameras from an environment external to the enclosure.

Optionally, the gimbal system is configured for use in controlling an orientation of the enclosure.

Optionally, the processing resource is configured to control the gimbal system so as to control the orientation of the enclosure in response to one or more signals received from the sensor arrangement so as to stabilise the enclosure against motion of the imaging system.

Optionally, the FoV of the NFOV camera is fixed relative to the FoV of the WFoV camera. Optionally, the NFoV camera is fixed relative to the WFoV camera.

Optionally, the FoV of the NFOV camera is adjustable relative to the FoV of the WFoV camera to allow the FoV of the NFoV camera to be scanned independently of the FoV of the WFoV camera so that the NFoV camera may capture the NFoV images of a plurality of regions of the wind turbine.

Optionally, an orientation of the NFoV camera is adjustable relative to an orientation of the WFoV camera so that the orientation of the NFoV camera may be scanned independently of the orientation of the WFOV camera to allow the NFoV camera to capture the NFoV images of a plurality of regions of the wind turbine.

According to an aspect of the present disclosure there is provided an inspection system for inspecting the moving blades of a wind turbine, the inspection system comprising a movable platform and the imaging system as described above, wherein the imaging system is attached to the movable platform.

Optionally, the movable platform comprises a propulsion system and a processing resource.

Optionally, the propulsion system and the processing resource of the movable platform are configured for communication with one another.

Optionally, the processing resource of the movable platform is configured for communication with the processing resource of the imaging system, wherein the processing resource of the imaging system is configured to cause the processing resource of the movable platform to control the propulsion system so as to move the movable platform along a path around the wind turbine.

Optionally, the processing resource of the imaging system is configured to cause the imaging system to image each moving blade of the wind turbine from one or more predetermined different vantage points along the path.

Optionally, the processing resource of the imaging system is configured to cause the imaging system to image one or both sides of each moving blade of the wind turbine from one or more predetermined different vantage points along the path and/or to image one or both edges of each moving blade of the wind turbine from one or more predetermined different vantage points along the path.

Optionally, the movable platform comprises a sensor arrangement.

Optionally, the sensor arrangement of the movable platform comprises a GPS sensor, a compass, one or more accelerometers, one or more gyroscopic sensors, and/or an inertial measurement unit.

Optionally, the sensor arrangement of the movable platform comprises an Attitude Heading and Reference System (AHARS).

Optionally, the processing resource of the imaging system is configured to receive a signal including information relating to the wind direction and/or the direction in which the wind turbine is pointing. Optionally, the imaging system comprises a wireless communications interface for receiving a signal including information relating to the wind direction and/or the direction in which the wind turbine is pointing from a transmitter or a transponder of the wind turbine. Optionally, the wireless communications interface and the processing resource of the imaging system are configured for communication with each other.

Optionally, the imaging system or the movable platform includes a wind direction sensor for measuring the wind direction. Optionally, the wind direction sensor and the processing resource of the imaging system are configured for communication with each other.

Optionally, the imaging system comprises a memory for storing a position of the wind turbine and the length of the blades of the wind turbine. Optionally, the memory and the processing resource of the imaging system are configured for communication with each other.

Optionally, the processing resource of the imaging system is configured to determine the path around the wind turbine based on the wind direction and/or the direction in which the wind turbine is pointing, the stored position of the wind turbine, and the stored length of the blades of the wind turbine.

Optionally, the movable platform comprises a terrestrial vehicle, a floating vehicle, or an airborne vehicle such as a drone.

Optionally, the wind turbine is an onshore wind turbine or an offshore wind turbine.

Optionally, the functionality of the processing resource of the imaging system and the functionality of the processing resource of the movable platform is combined in a single processing resource which is provided with, forms part of, or is located within, the imaging system.

It should be understood that any one or more of the optional features of any one of the foregoing aspects of the present disclosure may be combined with any one or more of the optional features of any of the other foregoing aspects of the present disclosure.

### BRIEF DESCRIPTION OF THE DRAWINGS

Systems and methods for imaging and inspecting one or more blades of a moving wind turbine will now be described by way of non-limiting example only with reference to the accompanying drawings of which:

FIG. 1 is a schematic side view of a wind turbine inspection system inspecting the moving blades of a wind turbine;

FIG. 2A is a photograph of a rear end of an imaging system of the wind turbine inspection system of FIG. 1;

FIG. 2B is a photograph of the rear end of the imaging system of FIG. 2A shown in use imaging the moving blades of a wind turbine;

FIG. 2C is a first photograph showing a front end of the imaging system of FIG. 2A; and

FIG. 2D is a second photograph showing the front end of the imaging system of FIG. 2A;

FIG. 3 is a schematic block diagram of the inspection system of FIG. 1;

FIG. 4 is a schematic block diagram of an inspection method for inspecting the moving blades of a wind turbine;

FIG. 5 is a schematic plan view of the wind turbine inspection system of FIG. 1 in use inspecting a wind turbine.

FIG. 6 is a schematic front view of a wind turbine showing the positions at which the imaging system images different regions or sections of each moving blade of the wind turbine;

FIG. 7 is a schematic block diagram of an imaging method for imaging different regions or sections of each moving blade of the wind turbine;

FIG. 8 is a schematic front view of a wind turbine showing the fields-of-view of NFoV and WFoV cameras of the imaging system of FIGS. 2A-2D;

FIG. 9 is a schematic block diagram of the imaging steps of the imaging method of FIG. 7;

FIG. 10 is a photograph of a WFoV image of the moving blades of a wind turbine captured using a WFoV camera of the imaging system of FIGS. 2A-2D and a graphical user interface showing the determined angles of the edges of the moving blades of a wind turbine; and

FIG. 11 is a photograph of a NFoV image of a region or section of a moving blade captured using a NFoV camera of the imaging system of FIGS. 2A-2D.

### DETAILED DESCRIPTION OF THE DRAWINGS

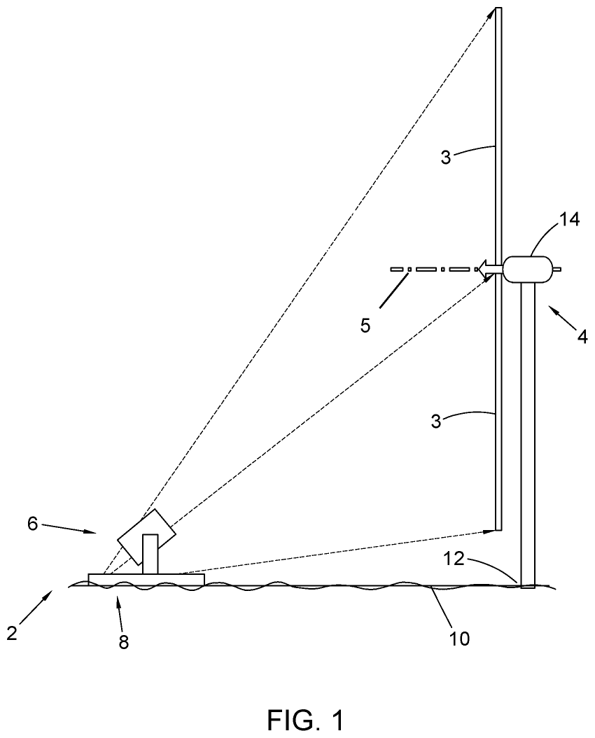

Referring initially to FIG. 1 there is shown a schematic side view of a wind turbine inspection system generally designated 2 inspecting the moving blades 3 of a wind turbine in the form of an offshore wind turbine generally designated 4. The wind turbine blades 3 rotate in a plane of rotation about an axis of rotation 5. The wind turbine inspection system 2 includes an imaging system generally designated 6 mounted on a movable platform in the form of an autonomous floating vehicle 8. In some embodiments, the autonomous floating vehicle 8 may be an autonomous service vehicle (ASV) or a crew transfer vehicle (CTV). In use, the wind turbine inspection system 2 is positioned on the surface 10 of the sea at a position which is separated from a base 12 of the wind turbine 4 by a stand-off distance which is approximately equal to the height of a nacelle 14 of the wind turbine 4 above the base 12 of the wind turbine 4 and the imaging system 6 is angled upwardly towards the plane of rotation of the wind turbine blades 3 at an acute look-up angle such as a look-up angle of approximately 45° relative to the plane of rotation of the wind turbine blades 3.

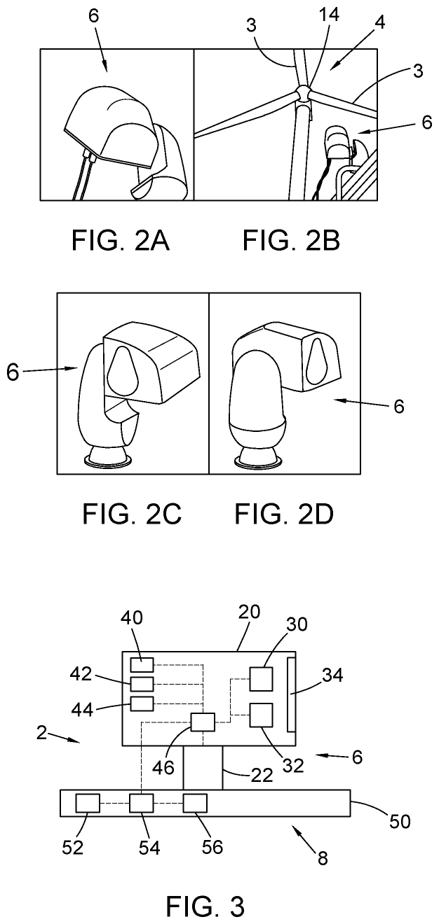

FIGS. 2A, 2C and 2D are photographs of the imaging system 6. FIG. 2B is a photograph of the imaging system 6 in use angled upwardly towards the nacelle 14 of the wind turbine 4.

Referring now to FIG. 3 there is shown a more detailed schematic of the wind turbine inspection system 2. The imaging system 6 includes a sealed enclosure 20 and a gimbal system 22 which connects the enclosure 20 to the movable platform 8. The imaging system 6 further includes a wider field-of-view (WFoV) camera in the form of a visible WFoV camera 30, a narrower field-of-view (NFoV) in the form of a visible NFoV camera 32, and a transparent window 34 for admitting light from an environment external to the enclosure 20 to the cameras 30, 32. The NFoV camera 32 has the same sampling resolution as the WFoV camera 30 but a higher spatial resolution than the WFoV camera by virtue of having a narrower FOV than the WFOV camera 30. The NFoV camera 32 has an integration time of less than 100 μs.

The imaging system 6 further includes a sensor arrangement 40 which includes a GPS sensor for measuring a position of the enclosure 20, and a compass, one or more accelerometers, one or more gyroscopic sensors, and/or an inertial measurement unit for measuring an orientation and/or an acceleration of the enclosure 20. For example, the sensor arrangement 40 may comprise an Attitude Heading and Reference System (AHARS). The imaging system 6 also includes a memory 42, a wireless communication interface 44 for communicating wirelessly with a remote controller or processing resource (not shown), and a processing resource 46.

The autonomous floating vehicle 8 includes a floating platform 50, a propulsion system 52, and a processing resource 54.

As indicated by the dashed lines in FIG. 3, the processing resource 46 of the imaging system 6 is configured for communication with the cameras 30, 32, the one or more sensors 40, the memory 42, the wireless communication interface 44, and the processing resource 54 of the autonomous floating vehicle 8. Similarly, the processing resource 54 of the autonomous floating vehicle 8 is configured for communication with the propulsion system 52 of the autonomous floating vehicle 8.

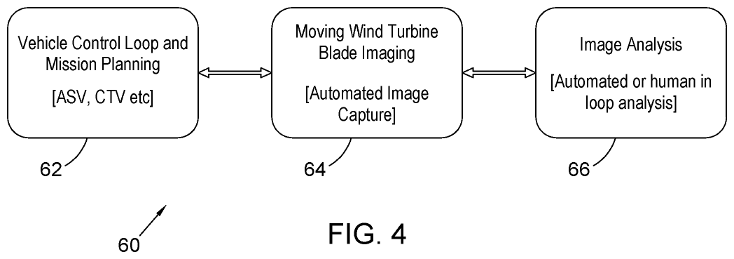

In use, the wind turbine inspection system 2 inspects the moving blades 3 of the wind turbine 4 according to the inspection method 60 depicted in FIG. 4. The inspection method 60 includes three general activities categorised as a vehicle control loop and mission planning step 62, a moving wind turbine blade imaging step 64, and an image analysis step 66.

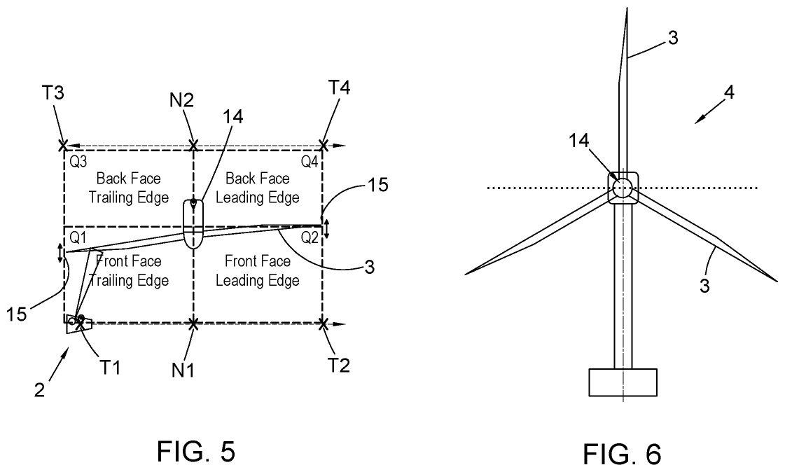

As will now be described in more detail with reference to FIG. 5, the vehicle control loop and mission planning step 62 involves controlling the autonomous floating vehicle 8 so as to travel along a path around the wind turbine 4. Specifically, the processing resource 46 of the imaging system 6 is configured to receive a signal including information relating to the wind direction and/or the direction in which the wind turbine 4 is pointing from a transmitter or a transponder of the wind turbine 4 via the wireless communication interface 44 of the imaging system 6. The memory 42 of the imaging system 6 stores a position of the wind turbine 4 and the length of the blades 3. The processing resource 46 determines the path around the wind turbine 4 based on the wind direction and/or the direction in which the wind turbine 4 is pointing, the stored position of the wind turbine 4 and the stored length of the blades 3. The processing resource 46 of the imaging system 6 communicates with the processing resource 54 of the autonomous floating vehicle 8 causing the processing resource 54 of the autonomous floating vehicle 8 to control the propulsion system 52 so as to move the floating vehicle 8 autonomously along the path around the wind turbine 4. The processing resource 46 of the imaging system 6 then causes the imaging system 6 to image one or both sides of each moving blade 3 of the wind turbine 4 from one or more predetermined different vantage points along the path and/or to image one or both edges of each moving blade 3 of the wind turbine 4 from one or more predetermined different vantage points along the path.

For example, the predetermined different vantage points may include:
a first nacelle vantage point N1 positioned in line with the nacelle 14 at a stand-off distance in front of the plane of rotation of the moving blades 3, wherein the stand-off distance is equal to the height of the nacelle 14 above the base 12;
a second nacelle vantage point N2 positioned in line with the nacelle 14 at a stand-off distance behind the plane of rotation of the moving blades 3, wherein the stand-off distance is equal to the height of the nacelle 14 above the base 12;
a first tip vantage point T1 positioned in line with a position of a tip 15 of a moving blade 3 when the moving blade 3 is oriented horizontally at an angle of 270° with respect to the vertical when viewed from a front side of the plane of rotation of the moving blades 3 at a stand-off distance in front of the plane of rotation of the moving blades 3, wherein the stand-off distance is equal to the height of the nacelle 14 above the base 12;
a second tip vantage point T2 positioned in line with a position of a tip 15 of a moving blade 3 when the moving blade 3 is oriented horizontally at an angle of 90° with respect to the vertical when viewed from the front side of the plane of rotation of the moving blades 3 at a stand-off distance in front of the plane of rotation of the moving blades 3, wherein the stand-off distance is equal to the height of the nacelle 14 above the base 12;
a third tip vantage point T3 positioned in line with a position of a tip 15 of a moving blade 3 when the moving blade 3 is oriented horizontally at an angle of 90° with respect to the vertical when viewed from a rear side of the plane of rotation of the moving blades 3 at a stand-off distance behind the plane of rotation of the moving blades 3, wherein the stand-off distance is equal to the height of the nacelle 14 above the base 12; and
a fourth tip vantage point T4 positioned in line with a position of a tip 15 of a moving blade 3 when the moving blade 3 is oriented horizontally at an angle of 270° with respect to the vertical when viewed from the rear side of the plane of rotation of the moving blades 3 at a stand-off distance behind the plane of rotation of the moving blades 3, wherein the stand-off distance is equal to the height of the nacelle 14 above the base 12.

Moreover, the autonomous floating vehicle 8 is configured so as to move autonomously from one vantage point to the next. Once the processing resource 46 of the imaging system 6 has confirmed its location at any one of the vantage points, the processing resource 46 causes the imaging system 6 to image each moving blade 3 of the wind turbine 4 between the nacelle 14 and the tip 15 of each moving blade 3 according to the moving wind turbine blade imaging step 64 of FIG. 4 as will be described in more detail below. As illustrated in FIG. 6, from each vantage point, the imaging system 6 images, different regions or sections of each moving blade 3 of the wind turbine 4 at a plurality of different positions, for example 20 equally spaced positions, from the nacelle 14 to the tip 15. It should be understood that the imaging system 6 is configured to pause image capture whilst the autonomous floating vehicle 8 moves between the different vantage points.

For example, the autonomous floating vehicle 8 may be configured so as to move autonomously along the path between the vantage points in the order: N1, T1, N1, T2 as indicated by the dashed line in FIG. 5 in front of the plane of rotation of the moving blades 3 of the wind turbine 4. Whilst positioned at vantage point N1, the imaging system 6 images different regions or sections of each moving blade 3 of the wind turbine 4 at a plurality of different positions from the nacelle 14 to the tip 15 of each moving blade 3 (when each moving blade is at an angle of 270° relative to the vertical when viewed from the front side of the plane of rotation of the moving blades 3). Then, whilst positioned at vantage point T1, the imaging system 6 images different regions or sections of each moving blade 3 of the wind turbine 4 at a plurality of different positions from the tip 15 of each moving blade 3 (when each moving blade is at an angle of 270° relative to the vertical when viewed from the front side of the plane of rotation of the moving blades 3) to the nacelle 14 of each moving blade 3. Then, whilst positioned at vantage point N1 again, the imaging system 6 images different regions or sections of each moving blade 3 of the wind turbine 4 at a plurality of different positions from the nacelle 14 to the tip 15 of each moving blade 3 (when each moving blade is at an angle of 90° relative to the vertical when viewed from the front side of the plane of rotation of the moving blades 3). Then, whilst positioned at vantage point T2, the imaging system 6 images different regions or sections of each moving blade 3 of the wind turbine 4 at a plurality of different positions from the tip 15 of each moving blade 3 (when each moving blade is at an angle of 90° relative to the vertical when viewed from the front side of the plane of rotation of the moving blades 3) to the nacelle 14 of each moving blade 3.

The autonomous floating vehicle 8 may be configured so as to then move autonomously along the path between the vantage points in the order: N2, T3, N2, T4 as indicated by the dashed line in FIG. 5 behind the plane of rotation of the moving blades 3 of the wind turbine 4. For example, whilst positioned at vantage point N2, the imaging system 6 images different regions or sections of each moving blade 3 of the wind turbine 4 at a plurality of different positions from the nacelle 14 to the tip 15 of each moving blade 3 (when each moving blade is at an angle of 90° relative to the vertical when viewed from the rear side of the plane of rotation of the moving blades 3). Then, whilst positioned at vantage point T3, the imaging system 6 images different regions or sections of each moving blade 3 of the wind turbine 4 at a plurality of different positions from the tip 15 of each moving blade 3 (when each moving blade is at an angle of 90° relative to the vertical when viewed from the rear side of the plane of rotation of the moving blades 3) to the nacelle 14 of each moving blade 3. Then, whilst positioned at vantage point N2 again, the imaging system 6 images different regions or sections of each moving blade 3 of the wind turbine 4 at a plurality of different positions from the nacelle 14 to the tip 15 of each moving blade 3 (when each moving blade is at an angle of 270° relative to the vertical when viewed from the rear side of the plane of rotation of the moving blades 3). Then, whilst positioned at vantage point T4, the imaging system 6 images different regions or sections of each moving blade 3 of the wind turbine 4 at a plurality of different positions from the tip 15 of each moving blade 3 (when each moving blade is at an angle of 270° relative to the vertical when viewed from the rear side of the plane of rotation of the moving blades 3) to the nacelle 14 of each moving blade 3.

Moreover, it should be understood that, during the vehicle control loop and mission planning and the moving wind turbine blade imaging steps 62, 64 described above with reference to FIGS. 4-6, the processing resource 46 of the imaging system 6 repeatedly determines or measures its position and orientation relative to the wind turbine 4. Specifically, the GPS sensor of the sensor arrangement 40 measures the position of the imaging system 6, the memory 42 of the imaging system 6 stores GPS co-ordinates of the wind turbine 4, and the processing resource 46 determines its position relative to the wind turbine 4 from the measured position of the imaging system 6 and the stored GPS co-ordinates of the wind turbine 4. The processing resource 46 also determines the orientation of the imaging system 6 from one or more signals received from the sensor arrangement 40.

At the beginning of the vehicle control loop and mission planning step 62, the processing resource 46 of the imaging system 6 communicates with the processing resource 54 of the autonomous floating vehicle 8 and causes the processing resource 54 of the autonomous floating vehicle 8 to control the propulsion system 52 of the autonomous floating vehicle 8 to manoeuver the autonomous floating vehicle 8 to the first vantage point, e.g. N1, along the path around the wind turbine 4.

At the beginning of the vehicle control loop and mission planning step 62, the processing resource 46 of the imaging system 6 also controls the gimbal system 22 so as to point the WFOV camera 30 towards the nacelle 14 of the wind turbine 4. As will be described in more detail below, the processing resource 46 of the imaging system 6 also controls the gimbal system 22 so as to stabilise the enclosure 20 against motion of the imaging system 6 to thereby ensure that the imaging system 6 points towards a selected point in inertial space and that the fields of view of the WFOV camera 30 and the NFoV camera 32 are stabilised against motion of the imaging system 6. The processing resource 46 of the imaging system then identifies the position of the nacelle 14 in the FoV of the WFoV camera 30 using image processing by looking for a point in the WFoV images captured by WFoV camera 30 from which the moving blades 3 of the wind turbine 4 protrude. Then, the processing resource 46 controls the gimbal system 22 so that the nacelle 14 is in the centre of the FoV of the WFoV camera 30. This is known as the “home” point. The processing resource 46 uses the stored length of the blades 3 and a range from the imaging system to the wind turbine 4 measured using the GPS sensor of the sensor arrangement 40 to determine a number of discrete angles or orientations of the enclosure 20 including the WFOV camera 30 and the NFoV camera 32 for scanning the WFOV camera 30 and the NFoV camera 32 from “home” to the tip, or from the tip to “home” to allow the NFoV camera 32 to capture a plurality of overlapping NFoV images of the blade 3.

Once each blade 3 has been imaged from “home” to the tip or from the tip to home from the first vantage point, the processing resource 46 of the imaging system 6 communicates with the processing resource 54 of the autonomous floating vehicle 8 and causes the processing resource 54 of the autonomous floating vehicle 8 to control the propulsion system 52 of the autonomous floating vehicle 8 to manoeuver the autonomous floating vehicle 8 to the next vantage point along the path based on the stored length of the blades 3. The sensor arrangement 40 tracks the position and orientation of the imaging system 6 during movement along the path between vantage points so that the processing resource 46 of the imaging system 6 can verify that the imaging system 6 has reached the next vantage point with the correct orientation.

It should be understood that imaging the moving blades 3 from an acute look-up angle such as a look-up angle of approximately 45° as described with referenced to FIG. 1 and from any two diagonally opposed quadrants of the quadrants Q1-Q4 shown in FIG. is sufficient to image the pressure and sucking surfaces of each blade 3 and to image both the leading and trailing edges of each blade 3, but that imaging the moving blades 3 from all four quadrants as described above ensures continuity of data capture and provides some redundancy so as to enhance the robustness of the imaging method.

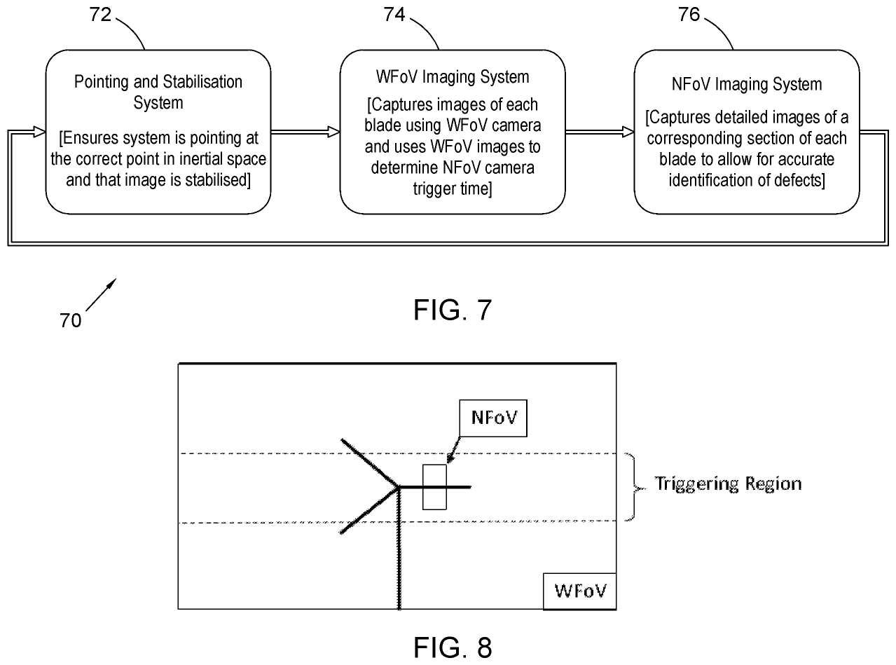

As described above, whilst positioned at each vantage point, the imaging system 6 images different regions or sections of each moving blade 3 of the wind turbine 4 at a plurality of positions between the nacelle 14 and the tip 15 of the blade 3 according to the imaging method 70 depicted in FIG. 7. At step 72 of the imaging method 70, the processing resource 46 of the imaging system 6 controls the gimbal system 22 so as to control the orientation of the enclosure 20 in response to one or more signals received from the sensor arrangement 40 so as to stabilise the enclosure 20 against motion of the imaging system 6 to thereby ensure that the imaging system 6 is pointing at the correct point in inertial space and that the fields of view of the WFOV camera 30 and the NFoV camera 32 are stabilised during the imaging of the different regions or sections of each moving blade 3.

At step 74 of the imaging method 70, the processing resource 46 of the imaging system 6 controls the WFoV camera 30 to capture a plurality of WFoV images of at least part of each moving blade 3 of the wind turbine 4 in the FoV of the WFoV camera 30 as depicted in FIG. 8. As will be described in more detail below, for each moving blade 3, the processing resource 46 of the imaging system 6 uses the captured plurality of WFoV images of at least part of the moving blade 3 to determine a trigger time when one or both of the edges of the moving blade 3 are in a triggering region which has a known spatial relationship relative to a FoV of the NFOV camera 32. As shown in FIG. 8, the triggering region may be larger in size than the FoV of the NFoV camera 32 and the triggering region may be oriented horizontally. The processing resource 46 of the imaging system 6 then uses the determined trigger time and the known spatial relationship between the triggering region and the FoV of the NFoV camera 32 to calculate one or more NFoV image capture times when the edge of the moving blade 3, or a body of the moving blade 3, is, or will be, in the FoV of the NFoV camera 32.

At step 76 of the imaging method 70, the processing resource 46 controls the NFOV camera 32 to capture one or more NFoV images of the region or section of the moving blade 3 in the NFoV of the NFoV camera 32 shown in FIG. 8 at the calculated one or more NFoV image capture times.

Specifically, step 74 of the imaging method 70 comprises using the WFoV camera 30 to repeatedly capture WFoV images of at least part of the moving blade 3 of the wind turbine 4 at a plurality of known WFoV image capture times, wherein successive known WFoV image capture times are separated by a sampling period which is less than a period of rotation of the blade 3 of the wind turbine 4. For each WFOV image capture time, an angle of each edge of the moving blade 3 relative to a vertical reference direction is determined from the captured plurality of WFoV images of at least part of the moving blade 3.

Step 74 of the imaging method 70 further comprises identifying the trigger time to be the current WFoV image capture time if the angles of one or both of the edges of the moving blade 3 relative to the vertical reference direction at the most recent WFoV image capture time fall inside a predetermined range of angles defining the triggering region relative to the vertical reference direction and if the angles of both edges of the moving blade 3 relative to the vertical reference direction at the previous WFoV image capture time, which immediately precedes the current WFoV image capture time, fall outside the predetermined range of angles defining the triggering region relative to the vertical reference direction. The predetermined range of angles relative to the vertical reference direction defining the triggering region depends on the vantage point. For example, the predetermined range of angles defining the triggering region relative to the vertical reference direction may be between 265° and 275°, between 268° and 272° or between 269° and 271° for vantage points T1 and N1, or the predetermined range of angles defining the triggering region relative to the vertical reference direction may be between 85° and 95°, between 88° and 92° or between 89° and 91° for vantage points N1 and T2.

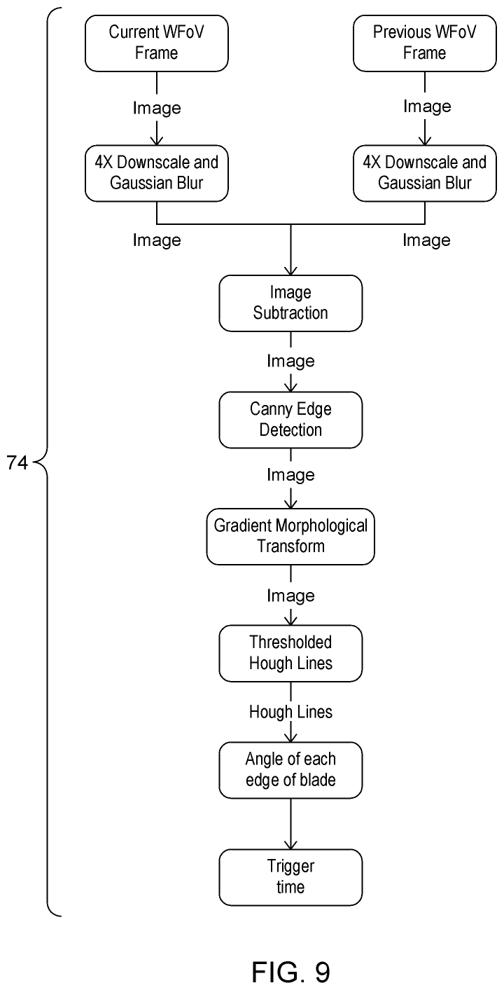

As illustrated in FIG. 9, determining the angle of each edge of the moving blade 3 comprises determining an edge map of the moving blade 3 at a current WFoV image capture time. Specifically, determining the angle of each edge of the moving blade 3 at a current WFoV image capture time comprises subtracting the previous WFoV image of at least part of the moving blade 3 captured at the previous WFoV image capture time, which immediately precedes the current WFoV image capture time, from the current WFoV image of at least part of the moving blade 3 captured at the current WFoV image capture time to thereby generate a subtracted WFOV image of at least part of the moving blade. Determining the angle of each edge of the moving blade 3 at the current WFoV image capture time further comprises applying Canny edge detection to the subtracted WFoV image, applying a gradient morphological transform to generate thresholded Hough lines, and determining the angles of the edges of the moving blade 3 relative to the vertical reference direction at the current WFOV image capture time to be the angles of the thresholded Hough lines relative to the vertical reference direction at the given WFoV image capture time.

Determining the angle of the edge of the moving blade 3 relative to the vertical reference direction as described above may be more effective than using a global threshold to distinguish an image of the moving blade 3 from an area of the background such as an area of sky or sea, especially where the contrast between the moving blade 3 and the background is limited. Accordingly, identifying the trigger time as described above may result in more robust triggering than a triggering method that relies on the use of a global threshold to distinguish an image of the moving blade 3 from an area of the background.

As already described above, the processing resource 46 then identifies the trigger time for the moving blade 3 by comparing the determined angles of the edges of the moving blade 3 relative to the vertical reference direction with the predetermined range of angles defining the triggering region relative to the vertical reference direction. The processing resource 46 then uses the determined trigger time to calculate one or more NFoV image capture times when the edge of the moving blade 3, or a body of the moving blade 3, is in the FoV of the NFoV camera 32 and controls the NFoV camera 32 to capture one or more NFoV images of the region or section of the moving blade 3 in the FoV of the NFOV camera 32 shown in FIG. 8 at the calculated one or more NFoV image capture times at step 76 of the imaging method 70.

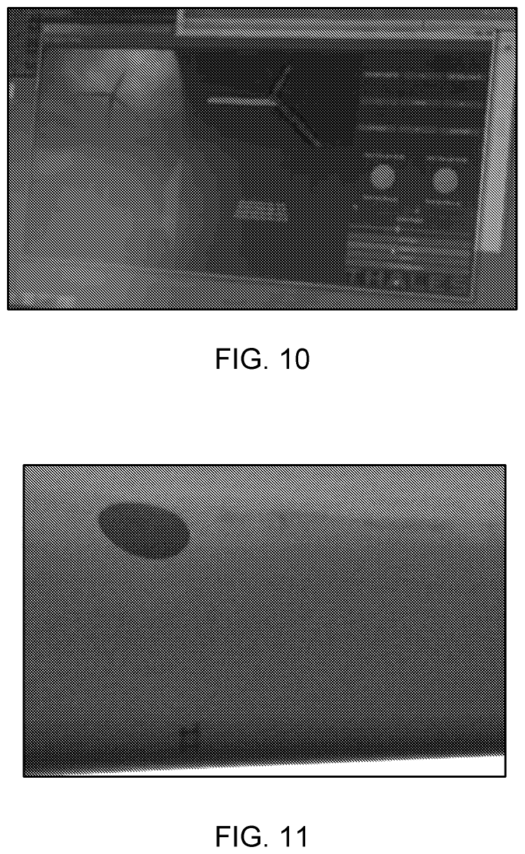

An example of a WFoV image of the moving blades 3 captured using the WFoV camera 30 and a graphical user interface showing the determined angles of the edges of the moving blades 3 are shown in FIG. 10. An example of a NFoV image of a region or section of a moving blade 3 captured using the NFoV camera 32 is shown in FIG. 11.

As may be appreciated from the foregoing description, the vehicle control loop and mission planning step 62 and the imaging step 64 may be used to inspect the sucking and pressure surfaces and both the leading and trailing edges of all of the moving blades 3 of a wind turbine 4 such as an offshore wind turbine 4 in a way that is partially or fully automated.

The inspection method 60 depicted in FIG. 4 finishes with the image analysis step 66 during which the one or more NFoV images of each region or section of each moving blade 3 captured from each vantage point are analysed so as to identify any surface damage or defects on one or both surfaces or edges of the moving blade 3. The image analysis step 66 may be automated. For example, the processing resource 46 may analyse the one or more NFoV images of each region or section of each moving blade 3 captured from each vantage point by comparing the one or more NFoV images of each region or section of each moving blade 3 captured from each vantage point with one or more corresponding previous or historical NFoV images of each region or section of each moving blade 3 captured from each vantage point or by comparing the one or more NFoV images of each region or section of each moving blade 3 captured from each vantage point with one or more corresponding expected or reference NFoV images of each region or section of each moving blade 3 from each vantage point representative of a satisfactory, acceptable and/or pristine condition of each region or section of each moving blade 3 captured from each vantage point. The image analysis step 66 may use one or more AI methods. The image analysis step 66 may comprise extracting anomalies that could be defects. The image analysis step 66 may comprise determining the size and/or location of the anomalies and/or defects. The image analysis step 66 may comprise extracting meta data and comparing the extracted meta data with data that was captured previously. Additionally or alternatively, the image analysis step 66 may be performed manually.

The processing resource 46 may save the image data of the one or more NFoV images of each region or section of each moving blade 3 captured from each vantage point to the memory 42 for later analysis for the detection of any surface damage or defects on one or both surfaces or edges of each moving blade 3 of the wind turbine 4 once the inspection system 2 has captured all of the NFoV images of each region or section of each moving blade 3 from all of the vantage points and the inspection system 2.

Additionally or alternatively, the inspection system 2 may transmit the image data of the one or more NFoV images of each region or section of each moving blade 3 captured from each vantage point wirelessly to a remote controller or processing resource (not shown) via the wireless communication interface 44 for remote analysis for the detection of any surface damage or defects on one or both surfaces or edges of each moving blade 3 of the wind turbine 4.

As may be appreciated from the foregoing description, the method 60 for inspecting the moving blades 3 of a wind turbine 4 may be used to inspect the sucking and pressure surfaces and both the leading and trailing edges of all of the moving blades 3 of a wind turbine 4 such as an offshore wind turbine 4 in a way that is partially or fully automated.

The method 60 for inspecting the moving blades 3 of a wind turbine 4 is advantageous because it avoids having to interrupt rotation of the moving blades 3 and may therefore allow the wind turbine 4 to continue generating electricity during inspection. The wind turbine blade inspection method 60 is less time consuming than known rope survey or aerial vehicle wind turbine blade inspection methods. The wind turbine blade inspection method 60 is also safer than known rope survey wind turbine blade inspection methods and does not require the use of surveyors trained in rope survey techniques. The wind turbine blade inspection method 60 may be automated and does not rely on manual judgements or assessments of any damage or defects in the blades of the wind turbine.

The wind turbine blade inspection system 2 may be operated in harsher environmental conditions, for example in higher seas and/or higher winds, or when visibility is lower, than known wind turbine blade inspection systems. As a result of the imaging system 2 being mounted on the floating vehicle 8, the wind turbine blade inspection system 2 may be operated in closer proximity to other wind turbines such as other wind turbines which form part of the same wind farm as the wind turbine 4 under inspection than known wind turbine blade inspection systems which include an imaging system mounted on an aerial vehicle such as a drone.

The wind turbine blade inspection method 60 may be regarded as a “step-stare” technique which does not require the use of moving cameras or moving optical elements such as moving mirrors or the like to track the movement of the moving blades 3 of the wind turbine 4. As such, the inspection system 2 may be mechanically relatively simple. The step-stare wind turbine blade inspection method 60 may produce overlapping high resolution images of the different regions or sections of each moving blade 3. The short exposure time of the NFoV camera 32 of less than 100 μs may ensure that the NFoV images of the moving blades 3 are blur free. Although the step-stare wind turbine blade inspection method 60 requires the WFoV camera 30 to repeatedly capture images of each moving blades 3, the NFoV camera 32 only captures higher resolution images of the different regions or sections of a moving blade 3 when the moving blade 3 is in the NFoV of the NFoV camera 32, thereby reducing the amount of image data for analysis thereby reducing data storage requirements and/or simplifying data processing.

From the foregoing description, it should be understood that the wind turbine inspection system 2 can be incorporated within a mission planning system which pre-defines the task and instructs the autonomous floating vehicle 8 to survey a wind farm in conjunction with the imaging system 6. The imaging system 6 can also operate independently of the mission planner, the autonomous floating vehicle 8 or both. When embodied on the autonomous floating vehicle 8 there is a closed loop interaction between the imaging system 6 and the autonomous floating vehicle 8. The imaging system 6 instructs the autonomous floating vehicle 8 to move between four quadrants around the wind turbine 4 to inspect the wind turbine 4 and specifies which surfaces of the wind turbine 4 are scanned from each quadrant. It should be noted that it is only necessary for the imaging system 6 to image the wind turbine 4 from two diagonally opposed quadrants for a complete scan of the wind turbine 4. However, all four quadrants may be imaged to ensure continuity of data capture and to build some redundancy into the inspection system 2. When used in conjunction with an autonomous floating vehicle 8, the autonomous floating vehicle 8 may provide orientation information to enable the imaging system 6 to be actively stabilised prior to imaging of the wind turbine 4 from each quadrant. The imaging system 6 may be automatically oriented to point at an angle of 45 degrees to the plane of rotation of the blades 3. This is chosen to allow capture of the images of the leading and trailing edges of each blade 3. This significantly reduces the time to survey all blades 3. The triggering system applies image processing to images captured by the WFOV camera 30 to estimate when each blade 3 enters a FoV of the NFoV camera 32. Once a blade 3 is detected to be in the FoV of the NFoV camera 32, several images of each blade segment are automatically captured at a short integration time <100 μs approximately to minimise the effect of motion blur on captured imagery. The imaging system 6 is then panned and stopped along the blade 3, capturing overlapping images, to ensure that a complete survey of each blade 3 is completed from each quadrant. The procedure is repeated for all four quadrants. The output is a set of images of the moving wind turbine 4 to then be processed by an operator or an automatic blade defect system. The methods can be applied to cameras in any modality, including but not no limited to thermal (mid-wave and long-wave), short-wave infra-red, visible monochrome and colour.

One of ordinary skill in the art will understand that various modifications may be made to the embodiments of the present disclosure described above without departing from the scope of the present invention as defined according to the appended claims. For example, rather than determining the trigger time to be the time when one or more edges of the moving blades is in the triggering region, the wind turbine blade inspection method may determine the trigger time to be the time when one or more edges of the moving blades will be in the triggering region. Specifically, using the captured plurality of WFoV images of at least part of the moving blade 3 to determine the trigger time may comprise:
determining first and second angles of each edge of the moving blade 3 relative to a reference direction at first and second known WFoV image capture times of captured first and second WFoV images respectively of the captured plurality of WFoV images of at least part of the moving blade 3;
determining a speed of rotation of the moving blade 3 based on the determined first and second angles of one or both edges of the moving blade 3 corresponding to the first and second known WFoV image capture times; and
using one or both of the first and second known WFoV image capture times and the determined speed of rotation of the moving blade 3 to calculate the trigger time when one or both of the angles of the edges of the moving blade 3 will enter a predetermined range of angles relative to the reference direction which define the triggering region.

Moreover, determining the first or second angle of each edge of the moving blade 3 relative to the reference direction may comprise:
subtracting the previous captured WFOV image of at least part of the moving blade 3 captured at the previous WFoV image capture time, which immediately precedes the first or second known WFoV image capture time, from the captured first or second WFoV image of at least part of the moving blade 3 captured at the first or second known WFoV image capture time to generate a subtracted WFoV image of at least part of the moving blade 3 corresponding to the first or second known WFoV image capture time;
applying Canny edge detection to the subtracted WFoV image;
applying a gradient morphological transform to generate thresholded Hough lines; and
determining the first or second angle of each edge of the moving blade 3 relative to the reference direction at the first or second known WFoV image capture time to be the angles of the thresholded Hough lines relative to the reference direction.

The WFoV camera may be sensitive to one or more of the following: visible light, near-infrared (NIR) light, short-wavelength infrared (SWIR) light, mid-wavelength infrared (MWIR) light, and long-wavelength infrared (LWIR) light. The WFoV camera may be a monochrome camera or a colour camera.

The NFoV camera may be sensitive to one or more of the following: visible light, near-infrared (NIR) light, short-wavelength infrared (SWIR) light, mid-wavelength infrared (MWIR) light, and long-wavelength infrared (LWIR) light. The NFoV camera may be a monochrome camera or a colour camera.

Although the imaging system 6 has been described above as being mounted on a floating vehicle 8 for the inspection of an offshore wind turbine, in one or more other embodiments, the imaging system 6 may be mounted on a terrestrial vehicle for the inspection of an onshore wind turbine. In one or more other embodiments, the imaging system 6 may be mounted on an aerial vehicle such as a drone for the inspection of an offshore wind turbine or an onshore wind turbine.

It should also be understood that essentially the same methods described above for inspecting an offshore wind turbine using an imaging system 6 mounted on a floating vehicle 8 may be used for inspecting an onshore wind turbine using an imaging system 6 mounted on a terrestrial vehicle or for inspecting an offshore or an onshore wind turbine using an imaging system 6 mounted on an aerial vehicle such as a drone. Moreover, when the imaging system 6 is mounted on an aerial vehicle such as a drone, the wind turbine may be imaged using an acute look-up angle such as a look-up angle of approximately 45° or an acute look-down angle such as a look-down angle of approximately 45°.

As described above, imaging the moving blades 3 from an acute look-up angle and from any two diagonally opposed quadrants of the quadrants Q1-Q4 shown in FIG. allows imaging of the pressure and sucking surfaces of each blade 3 and imaging of both the leading and trailing edges of each blade 3. Similarly, it should be understood that imaging the moving blades 3 from an acute look-down angle and from any two diagonally opposed quadrants of the quadrants Q1-Q4 shown in FIG. 5 also allows imaging of the pressure and sucking surfaces of each blade 3 and imaging of both the leading and trailing edges of each blade 3.

In the imaging system 6 described above, the sensor arrangement 40 of the imaging system was described as including the GPS sensor and the compass. Additionally or alternatively, the floating vehicle 8 may comprise a sensor arrangement 56 which includes a GPS sensor and a compass for essentially the same purpose as the GPS sensor and the compass of the sensor arrangement 40 of the imaging system 6.

As described above, the processing resource 46 of the imaging system 6 uses a GPS signal received from the GPS sensor and known GPS co-ordinates of the wind turbine 4 to determine the position of the imaging system 6 relative to the wind turbine 4. Additionally or alternatively, the wind turbine 4 may include a transmitter or a transponder which transmits or broadcasts a signal to the wireless communication interface 44 of the imaging system 6 and the processing resource 46 of the imaging system 6 may use the received signal to determine the position of the imaging system 6 relative to the wind turbine 4.

Rather than the wind turbine 4 measuring the wind direction and/or the direction in which the wind turbine is pointing and transmitting a signal including information relating to the wind direction and/or the direction in which the wind turbine is pointing to the imaging system 6, the imaging system 6 or the floating vehicle 8 may include a wind direction sensor for measuring the wind direction, wherein the wind direction sensor and the processing resource 46 of the imaging system 6 are configured for communication with each other.

The size, shape and/or orientation of the FoV of the WFOV camera, the FoV of the NFoV camera and/or the triggering region may be different to those described above. For example, although the triggering region is described above as being larger in size than the FoV of the NFoV camera, it should be understood that the triggering region may have any size relative to the size of the FoV of the NFoV camera. For example, the triggering region may have the same size as the FoV of the NFoV camera or may be greater or smaller in size to the FoV of the NFoV camera. A shape of the triggering region may be different to a shape of the FoV of the NFOV camera. One or more dimensions of the triggering region may be different to, for example greater than or smaller than, one or more corresponding dimensions of the FoV of the NFoV camera. An angular range defining the triggering region relative to the axis of rotation of the moving blades of the wind turbine may be different to, for example greater than or smaller than, an angular range defining the FoV of the NFoV camera relative to the axis of rotation of the moving blades of the wind turbine. A dimension of the triggering region in the vertical direction may be different to, for example greater than or smaller than, a dimension of the FoV of the NFoV camera in the vertical direction. A dimension of the triggering region in a radial direction relative to an axis of rotation of the moving blades of the wind turbine may be different to, for example greater than or smaller than, a dimension of the FoV of the NFoV camera in the radial direction. A dimension of the triggering region in the horizontal direction may be different to, for example greater than or smaller than, a dimension of the FoV of the NFOV camera in the horizontal direction. A position of the triggering region may be different to a position of the FoV of the NFoV camera. A position of the triggering region may have a known offset relative to a position of the FoV of the NFoV camera in a circumferential direction relative to the axis of rotation of the moving blades of the wind turbine.

A size of the triggering region may be adjustable. A shape of the triggering region may be adjustable. One or more dimensions of the triggering region may be adjustable. A position of the triggering region may adjustable, for example relative to the position of the FoV of the NFoV camera. An orientation of the triggering region may adjustable, for example relative to the orientation of the FoV of the NFoV camera.

It should be understood that using the WFOV and NFoV cameras to sequentially image the plurality of different regions of each moving blade may comprise using the WFoV and NFoV cameras to sequentially image the plurality of different regions of one of the moving blades and then using the WFoV and NFoV cameras to sequentially image the plurality of different regions of a different one of the moving blades until the plurality of different regions of each of the moving blades have been imaged.

Alternatively, using the WFOV and NFoV cameras to sequentially image the plurality of different regions of each moving blade may comprise using the WFoV and NFoV cameras to sequentially image the corresponding regions of each of the moving blades at one radial position and then using the WFoV and NFoV cameras to sequentially image the corresponding regions of each of the moving blades at a different one of the radial positions until the plurality of different regions of each of the moving blades have been imaged.

It should be understood that the WFoV and NFoV cameras 30, 32 are described above as being fixed relative to one another because such an imaging system is simpler mechanically. However, in an alternative embodiment, the FoV of the NFoV camera 32 may be adjustable relative to the FoV of the WFOV camera 30 so that the FoV of the NFoV camera 32 may be scanned independently of the FoV of the WFOV camera 30 to allow the NFoV camera 32 to capture the NFoV images of a plurality of regions of the wind turbine 4. For example, an orientation of the NFOV camera 32 may adjustable relative to an orientation of the WFoV camera 30 so that the orientation of the NFoV camera 32 may be scanned independently of the orientation of the WFOV camera 30 to allow the NFOV camera 32 to capture the NFoV images of a plurality of regions of the wind turbine 4.

Although the processing resource 46 of the imaging system 6 and the processing resource 54 of the autonomous floating vehicle 8 have been described as separate processing resources, the functionality of the processing resource 46 of the imaging system 6 and the functionality of the processing resource 54 of the autonomous floating vehicle 8 may be combined in a single processing resource which is provided with, forms part of, or is located within, the imaging system 6.

Each feature disclosed or illustrated in the present specification may be incorporated in any embodiment, either alone, or in any appropriate combination with any other feature disclosed or illustrated herein. In particular, one of ordinary skill in the art will understand that one or more of the features of the embodiments of the present disclosure described above with reference to the drawings may produce effects or provide advantages when used in isolation from one or more of the other features of the embodiments of the present disclosure and that different combinations of the features are possible other than the specific combinations of the features of the embodiments of the present disclosure described above.

The skilled person will understand that in the preceding description and appended claims, positional terms such as ‘above’, ‘along’, ‘side’, etc. are made with reference to conceptual illustrations, such as those shown in the appended drawings. These terms are used for ease of reference but are not intended to be of limiting nature. These terms are therefore to be understood as referring to an object when in an orientation as shown in the accompanying drawings.

Use of the term “comprising” when used in relation to a feature of an embodiment of the present disclosure does not exclude other features or steps. Use of the term “a” or “an” when used in relation to a feature of an embodiment of the present disclosure does not exclude the possibility that the embodiment may include a plurality of such features.

The use of any reference signs in the claims should not be construed as limiting the scope of the claims.

1.-27. (canceled)

28. A method for imaging the moving blades of a wind turbine, the method comprising:
using a wider field-of-view (WFoV) camera and a narrower field-of-view (NFoV) camera to image a plurality of regions of each of the moving blades by:
sequentially scanning a field-of-view (FoV) of the NFoV camera across a plurality of radial positions relative to an axis of rotation of the moving blades; and
using the WFoV and NFoV cameras to image, at each radial position, a corresponding region of each moving blade,
wherein using the WFOV and NFOV cameras to image, at any one of the radial positions, the corresponding region of any one of the moving blades comprises:
using the WFoV camera to capture a plurality of WFoV images of at least part of the moving blade in the FoV of the WFoV camera;
using the captured plurality of WFoV images of at least part of the moving blade to determine a trigger time when an edge of the moving blade is, or will be, in a triggering region;
using the determined trigger time and a known spatial relationship between the triggering region and a FoV of the NFoV camera to calculate one or more NFoV image capture times when the edge of the moving blade, or a body of the moving blade, is, or will be, in the FoV of the NFoV camera; and
using the NFoV camera to capture one or more NFoV images of the region of the moving blade at the calculated one or more NFoV image capture times.

29. The method as claimed in claim 28, wherein using the WFoV and NFOV cameras to sequentially image the plurality of different regions of each moving blade comprises using the WFoV and NFoV cameras to sequentially image the plurality of different regions of one of the moving blades and then using the WFoV and NFoV cameras to sequentially image the plurality of different regions of a different one of the moving blades until the plurality of different regions of each of the moving blades have been imaged.

30. The method as claimed in claim 28, wherein using the WFOV and NFOV cameras to sequentially image the plurality of different regions of each moving blade comprises using the WFoV and NFoV cameras to sequentially image the corresponding regions of each of the moving blades at one radial position and then using the WFoV and NFoV cameras to sequentially image the corresponding regions of each of the moving blades at a different one of the radial positions until the plurality of different regions of each of the moving blades have been imaged.

31. The method as claimed in claim 28, wherein sequentially scanning the FoV of the NFoV camera across the plurality of radial positions comprises sequentially re-orienting the NFoV camera so as to sequentially scan the FoV of the NFoV camera across the plurality of radial positions.

32. The method as claimed in claim 28, comprising performing the sequential scanning of the field-of-view (FoV) of the NFOV camera and the sequential imaging of the plurality of different regions of each moving blade autonomously according to a pre-programmed sequence.

33. The method as claimed in claim 28, wherein the WFOV and NFoV cameras form part of an imaging system and the method comprises stabilising the WFoV and NFoV cameras against motion of the imaging system and, optionally,
wherein the imaging system comprises an enclosure, wherein the WFOV and NFoV cameras are both located within, and fixed to, the enclosure, for example wherein the enclosure is sealed so as to isolate the WFoV and NFoV cameras from an environment external to the enclosure, and the method comprises stabilising the enclosure against motion of the imaging system.

34. The method as claimed in claim 28, comprising translating the WFoV and NFoV cameras together along a path around the wind turbine and using the WFoV and NFoV cameras to image each moving blade from one or more predetermined different vantage points on the path, for example translating the WFoV and NFoV cameras together along a path around the wind turbine and using the WFOV and NFoV cameras to image one or both sides of each moving blade from the one or more predetermined different vantage points on the path and/or to image one or both edges of each moving blade from the one or more predetermined different vantage points on the path, and optionally, wherein the method comprises translating the WFOV and NFoV cameras together along the path around the wind turbine autonomously and/or receiving a signal including information relating to the wind direction and/or the direction in which the wind turbine is pointing and determining the path around the wind turbine based on the wind direction and/or the direction in which the wind turbine is pointing, a known or stored position of the wind turbine, and a known or stored length of the blades of the wind turbine.

35. The method as claimed in claim 34, wherein each predetermined different vantage point is located at a position at or around the same level as a base of the wind turbine, wherein the position defines an acute angle relative to a plane of rotation of the moving blades of the wind turbine and, optionally, wherein the acute angle is in the region of 45°.

36. The method as claimed in claim 28, wherein using the WFoV camera to capture the plurality of WFoV images of at least part of the moving blade of the wind turbine comprises using the WFoV camera to repeatedly capture WFoV images of at least part of the moving blade of the wind turbine at a plurality of known WFoV image capture times, wherein successive known WFoV image capture times are separated by a sampling period which is less than a period of rotation of the blade of the wind turbine.

37. The method as claimed in claim 36, wherein using the captured plurality of WFoV images of at least part of the moving blade to determine the trigger time comprises:
determining, for each WFoV image capture time, an angle of each edge of the moving blade relative to a reference direction from the captured plurality of WFoV images of at least part of the moving blade;
identifying the trigger time to be the current WFoV image capture time if one or both angles of the edges of the moving blade relative to the reference direction at the current WFoV image capture time fall inside a predetermined range of angles defining the triggering region relative to the reference direction and if the angles of both edges of the moving blade relative to the reference direction at the previous WFoV image capture time, which immediately precedes the current WFoV image capture time, fall outside the predetermined range of angles defining the triggering region relative to the reference direction.

38. The method as claimed in claim 37, wherein determining the angle of each edge of the moving blade relative to the reference direction at a current WFoV image capture time comprises:
subtracting the previous captured WFoV image of at least part of the moving blade captured at the previous WFoV image capture time, which immediately precedes the current WFoV image capture time, from the current captured WFoV image of at least part of the moving blade captured at the current WFoV image capture time to generate a subtracted WFoV image of at least part of the moving blade;
applying Canny edge detection to the subtracted WFoV image;
applying a gradient morphological transform to generate thresholded Hough lines; and
determining the angles of the edges of the moving blade relative to the reference direction at the current WFoV image capture time to be the angles of the thresholded Hough lines relative to the reference direction.

39. The method as claimed in claim 36, wherein using the captured plurality of WFoV images of at least part of the moving blade to determine the trigger time comprises:
determining first and second angles of each edge of the moving blade relative to a reference direction at first and second known WFoV image capture times of captured first and second WFoV images respectively of the captured plurality of WFoV images of at least part of the moving blade;
determining a speed of rotation of the moving blade based on the determined first and second angles of one or both edges of the moving blade corresponding to the first and second known WFoV image capture times; and
using one or both of the first and second known WFoV image capture times and the determined speed of rotation of the moving blade to calculate the trigger time when one or both of the angles of the edges of the moving blade will enter a predetermined range of angles relative to the reference direction which define the triggering region.

40. The method as claimed in claim 39, wherein determining the first or second angle of each edge of the moving blade relative to the reference direction comprises:
subtracting the previous captured WFoV image of at least part of the moving blade captured at the previous WFoV image capture time, which immediately precedes the first or second known WFoV image capture time, from the captured first or second WFoV image of at least part of the moving blade captured at the first or second known WFoV image capture time to generate a subtracted WFoV image of at least part of the moving blade corresponding to the first or second known WFoV image capture time;
applying Canny edge detection to the subtracted WFoV image;
applying a gradient morphological transform to generate thresholded Hough lines; and
determining the first or second angle of each edge of the moving blade relative to the reference direction at the first or second known WFoV image capture time to be the angles of the thresholded Hough lines relative to the reference direction.

41. The method as claimed in claim 37, wherein the reference direction is vertically upwards and wherein the predetermined range of angles defining the triggering region relative to the reference direction is between 85° and 95°, between 88° and 92° or between 89° and 91°, or wherein the predetermined range of angles defining the triggering region relative to the reference direction is between 265° and 275°, between 268° and 272° or between 269° and 271°.

42. An imaging system for imaging the moving blades of a wind turbine, the imaging system comprising:
a wider field-of-view (WFoV) camera;
a narrower field-of-view (NFoV) camera; and
a processing resource configured for communication with the WFoV camera and the NFoV camera,
wherein the processing resource is configured to control the WFoV camera and the NFoV camera to image a plurality of regions of each of the moving blades by:
sequentially scanning a field-of-view (FoV) of the NFoV camera across a plurality of radial positions relative to an axis of rotation of the moving blades; and
using the WFoV and NFOV cameras to image, at each radial position, a corresponding region of each moving blade,
wherein controlling the WFoV and NFoV cameras to image, at any one of the radial positions, the corresponding region of any one of the moving blades comprises:
controlling the WFoV camera to capture a plurality of WFoV images of at least part of the moving blade of the wind turbine in a field-of-view (FoV) of the WFoV camera;
using the captured plurality of WFoV images of at least part of the moving blade to determine a trigger time when an edge of the moving blade is, or will be, in a triggering region;
using the determined trigger time and a known spatial relationship between the triggering region and a FoV of the NFoV camera to calculate one or more NFoV image capture times when the edge of the moving blade, or a body of the moving blade, is, or will be, in the FoV of the NFoV camera; and
controlling the NFoV camera to capture one or more NFoV images of the region of the moving blade at the calculated one or more NFoV image capture times.

43. The imaging system as claimed in claim 42, wherein the WFoV camera and/or the NFoV camera are sensitive to one or more of the following: visible light, near-infrared (NIR) light, short-wavelength infrared (SWIR) light, mid-wavelength infrared (MWIR) light, and long-wavelength infrared (LWIR) light.

44. The imaging system as claimed in claim 42, wherein the NFoV camera has a higher resolution than the WFoV camera and/or wherein the NFoV camera has an integration time of less than 1 ms, less than 500 s or less than 100 S.

45. The imaging system as claimed in claim 42, comprising a gimbal system for use in controlling an orientation of the WFoV and NFoV cameras, wherein at least one of:
the processing resource and the gimbal system are configured for communication;
the processing resource is configured to control the gimbal system so as to sequentially scan the FoV of the NFoV camera across the plurality of radial positions relative to the axis of rotation of the moving blades; or
the processing resource is configured to control the gimbal system so as to stabilise the WFoV and NFoV cameras against motion of the imaging system, for example wherein the imaging system comprises a sensor arrangement for measuring a position, orientation and/or an acceleration of the WFoV and NFoV cameras, wherein the processing resource and the sensor arrangement are configured for communication, and wherein the processing resource is configured to control the gimbal system so as to control the orientation of the WFoV and NFoV cameras in response to one or more signals received from the sensor arrangement so as to stabilise the WFoV and NFoV cameras against motion of the imaging system.

46. The imaging system as claimed in claim 42, comprising an enclosure, wherein the WFoV and NFoV cameras are both located within, and fixed to, the enclosure and, optionally, wherein the FoV of the NFOV camera is fixed or adjustable relative to the FoV of the WFoV camera, for example wherein an orientation of the NFOV camera is fixed or adjustable relative to an orientation of the WFoV camera and, optionally, wherein the enclosure is sealed so as to isolate the WFoV and NFoV cameras from an environment external to the enclosure and, optionally, wherein the imaging system comprises a gimbal system for use in controlling an orientation of the WFoV and NFoV cameras, wherein the gimbal system is configured for use in controlling an orientation of the enclosure and, optionally, wherein the processing resource is configured to control the gimbal system so as to control the orientation of the enclosure in response to one or more signals received from the sensor arrangement so as to stabilise the enclosure against motion of the imaging system.

47. An inspection system for inspecting the moving blades of a wind turbine, the system comprising a movable platform and the imaging system as claimed in claim 42, wherein the imaging system is attached to the movable platform, and optionally,
wherein at least one of:
the movable platform comprises a propulsion system, wherein the propulsion system of the movable platform and the processing resource are configured for communication with one another, wherein the processing resource is configured to control the propulsion system so as to move the movable platform along a path around the wind turbine and to cause the imaging system to image each moving blade of the wind turbine from one or more predetermined different vantage points along the path, for example wherein the processing resource is configured to control the propulsion system so as to move the movable platform along a path around the wind turbine and to cause the imaging system to image one or both sides of each moving blade of the wind turbine from one or more predetermined different vantage points along the path and/or to image one or both edges of each moving blade of the wind turbine from one or more predetermined different vantage points along the path;
the processing resource is configured to receive a signal including information relating to the wind direction and/or the direction in which the wind turbine is pointing and to determine the path around the wind turbine based on the wind direction and/or the direction in which the wind turbine is pointing, a stored position of the wind turbine, and a stored length of the blades of the wind turbine; or
the movable platform comprises a terrestrial vehicle, a floating vehicle, or an airborne vehicle such as a drone.
